(19) United States
(12) Patent Application Publication
(10) Pub. No.: US 2015/0236962 A1
(43) Pub. Date: Aug. 20, 2015

(54) METHOD AND SYSTEM FOR USING DYNAMIC BANDWIDTH DETECTION TO DRIVE QUALITY OF SERVICE CONTROL REFINEMENT

(71) Applicant: Exinda Networks PTY, Ltd. of Australia, Toronto (CA)

(72) Inventors: Greg Veres, Waterloo (CA); Randall G. Hunt, Lighthouse Point, FL (US)

(73) Assignee: Exinda Networks PTY, Ltd. of Australia, Toronto (CA)

(21) Appl. No.: 14/180,785

(22) Filed: Feb. 14, 2014

(51) Int. Cl. H04L 12/815; H04L 12/26; H04L 12/927; H04L 12/24

(52) U.S. Cl. CPC H04L 47/225; H04L 41/26; H04L 43/0882; H04L 47/805

(57) ABSTRACT

A method and system for adjusting computer network Quality of Service (QoS) controls to adapt to the dynamic nature of network circuit bandwidth. A network traffic management appliance determines the actual network bandwidth by measuring the actual used bandwidth and the unused bandwidth. The determined actual bandwidth is then fed back to the QoS management module to dynamically adjust to a shortage or excess of network bandwidth in comparison with a configured bandwidth.

### COPYRIGHT

A portion of the disclosure of this patent document contains material that is subject to copyright protection. The copyright owner has no objection to the facsimile reproduction by anyone of the patent disclosure, as it appears in the Patent and Trademark Office patent files or records, but otherwise reserves all copyright rights whatsoever.

### TECHNICAL FIELD

The present invention relates generally to improving quality of service on a computer network, and, more particularly, to changing traffic policies to provide more efficient network service based on actual network bandwidth.

### BACKGROUND

Commonly known local area networks (LAN) such as an Ethernet-based network communicate data via packets having a set format. Control of packet traffic in a network is critical to insure balanced communication flow and efficient transmission. Such packets are sent between a source network node and a destination node over a communication medium such as coaxial cable or twisted pair wire. Each packet typically has a header that contains limited routing information and a payload.

The most common method of local area network communication is the Ethernet protocol that is a family of frame-based computer networking technologies for local area networks. The Ethernet protocol is standardized as IEEE 802.3 and defines a number of wiring and signaling standards for the physical layer through means of network access at the Media Access Control (MAC)/Data Link Layer and a common addressing format.

The combination of the twisted pair versions of Ethernet for connecting end systems to the network, along with the fiber optic versions for site backbones, is the most widespread wired LAN technology. Ethernet nodes communicate by sending each other data packets that are individually sent and delivered. Each Ethernet node in a network is assigned a 48-bit MAC address. The MAC address is used both to specify the destination and the source of each data packet in the header. Network interface cards (NICs) or chips on each node normally do not accept packets addressed to other Ethernet nodes.

Various refinements may be used to improve network efficiency to LANs and other devices. For example, quality of service (QoS) devices perform prioritization and traffic shaping operations on computer network traffic sent over a network circuit to ensure a more controlled delivery of application data. When a network circuit is being completely utilized, prioritization is used by a QoS device to ensure that the most important application is given preferential access to the network circuit. Traffic shaping attempts to limit certain types of network traffic to a limited amount of bandwidth. The controls of a feature rich QoS device will allow lower priority traffic to use all of the network circuit if no other higher priority traffic is requesting use of the network circuit. Typical QoS devices use policies or rules to govern the prioritization and traffic shaping operations.

In order for policies directed toward prioritization and traffic shaping operations to work effectively, a QoS device requires knowledge of the bandwidth of the network circuit being used. This allows the QoS device to determine when prioritization is required as well as to determine how much bandwidth is used for lower priority applications before using traffic shaping to limit their use.

There are two problems that occur with known network circuit service providers. The first problem is that both the service provider and the customer specify the network bandwidth in very imprecise terms. For example, a customer may order a 50 Mb/s network circuit while the service provider will provide the customer with a network circuit that approximates the bandwidth (link speed) that was requested. The actual link bandwidth might be 49.95 Mb/s rather than 50 Mb/s. The second problem is that network circuit bandwidth may fluctuate during a set period based on conditions within the network infrastructure of the service provider. For example, there may be network circuit bandwidth fluctuations as great as 10% during a day depending on the network infrastructure.

All the policies governing a QoS device are specified as a percentage of the link's static bandwidth or as a fixed bandwidth allocation for each type of application traffic. For instance, a social media application may be allowed 5% of the link's static bandwidth or VoIP may be allocated 250 Kb/s from the link's static bandwidth. Such policies function efficiently if the specified value of the link's “fixed” bandwidth is truly the bandwidth of the provided link. When the bandwidth varies, the QoS device does not know that the bandwidth is now different than what the user specified as the link bandwidth. Thus, when a QoS device is configured with a static or fixed network circuit bandwidth, the result may be inaccurate traffic shaping and prioritization due to the discrepancy between the static network circuit bandwidth entered and the actual dynamic network circuit bandwidth.

If the specified network circuit bandwidth entered into the system is lower than the actual network circuit bandwidth, then bandwidth will be wasted as the QoS device starts to throttle traffic and enforce prioritization before the entire network circuit bandwidth is used. If the network circuit bandwidth entered into the system is higher than the actual network circuit bandwidth, then the QoS device will not effectively manage the traffic. This occurs because to the QoS device, there is available network circuit bandwidth left available. If no application makes use of that available network circuit, then the QoS device concludes that there are no further applications that want more network bandwidth than what is already being used. This condition fools the QoS device into failing to perform necessary actions to use any remaining available network circuit bandwidth.

Thus, there is a need for a QoS device that allows efficient prioritization of bandwidth of a network circuit when the true bandwidth of the network circuit is lower than the specified bandwidth. There is a further need for a QoS device that deploys available network capacity if the true bandwidth of the bandwidth circuit is momentarily more than the specified bandwidth. There is also a need for a network management system that can take advantage of additional temporary bandwidth caused by a burst from a network service provider.

### SUMMARY

According to one example, a method of efficient network traffic management is disclosed. A part of a bandwidth of a network circuit to provide network traffic is allocated to a computing device according to a policy based on a configured bandwidth of the network circuit. The actual bandwidth of the network circuit is determined. The policy for allocating a part of the bandwidth of the network circuit for the network traffic provided to the computing device is adjusted based on the determined actual bandwidth. The network traffic to the computing device is regulated according to the adjusted policy.

Another example is a traffic management appliance for regulating network traffic between a computing device and a network circuit having a configured bandwidth. The traffic management appliance includes a local area network port for receiving and transmitting traffic from the network circuit to the computing device according to a policy based on a configured bandwidth. A WAN port receives and transmits traffic from the network circuit. A network bandwidth detection module is coupled to the WAN port. A controller is coupled to the network bandwidth detection module to determine the actual bandwidth of the network circuit. A quality of service enforcement module is coupled to the LAN port for regulating network traffic to the computing device according to the policy. The quality of service enforcement module adjusts the policy based on the determined actual bandwidth of the network circuit.

Another example is a non-transitory, machine readable medium having stored thereon instructions for managing network traffic received through a network traffic appliance. The stored instructions comprise machine executable code, which when executed by at least one machine processor, causes the machine processor to allocate a part of a bandwidth of a network circuit to provide network traffic to a computing device according to a policy based on a configured bandwidth of the network circuit. The instructions also cause the processor to determine the actual bandwidth of the network circuit. The instructions also cause the processor to adjust the policy for allocating part of the bandwidth of the network circuit for the network traffic provided to the computing device based on the determined actual bandwidth. The instructions also cause the processor to regulate the network traffic to the computing device according to the adjusted policy.

Additional aspects of the invention will be apparent to those of ordinary skill in the art in view of the detailed description of various embodiments, which is made with reference to the drawings, a brief description of which is provided below.

### BRIEF DESCRIPTION OF THE DRAWINGS

FIG. 1 is a block diagram of an example network system including a traffic management appliance that allows efficient use of network circuit bandwidth by dynamic adjustment of QoS policies;

FIG. 2 is a block diagram of the traffic management appliance in FIG. 1;

FIG. 3 is a user interface showing policies for traffic management from the traffic management appliance in FIG. 1;

FIG. 4 is a graph showing the network bandwidth from the system in FIG. 1 over a period of time; and

FIG. 5 is a flow diagram showing the operation of the quality of service policies operated by the traffic management appliance in FIG. 1.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION

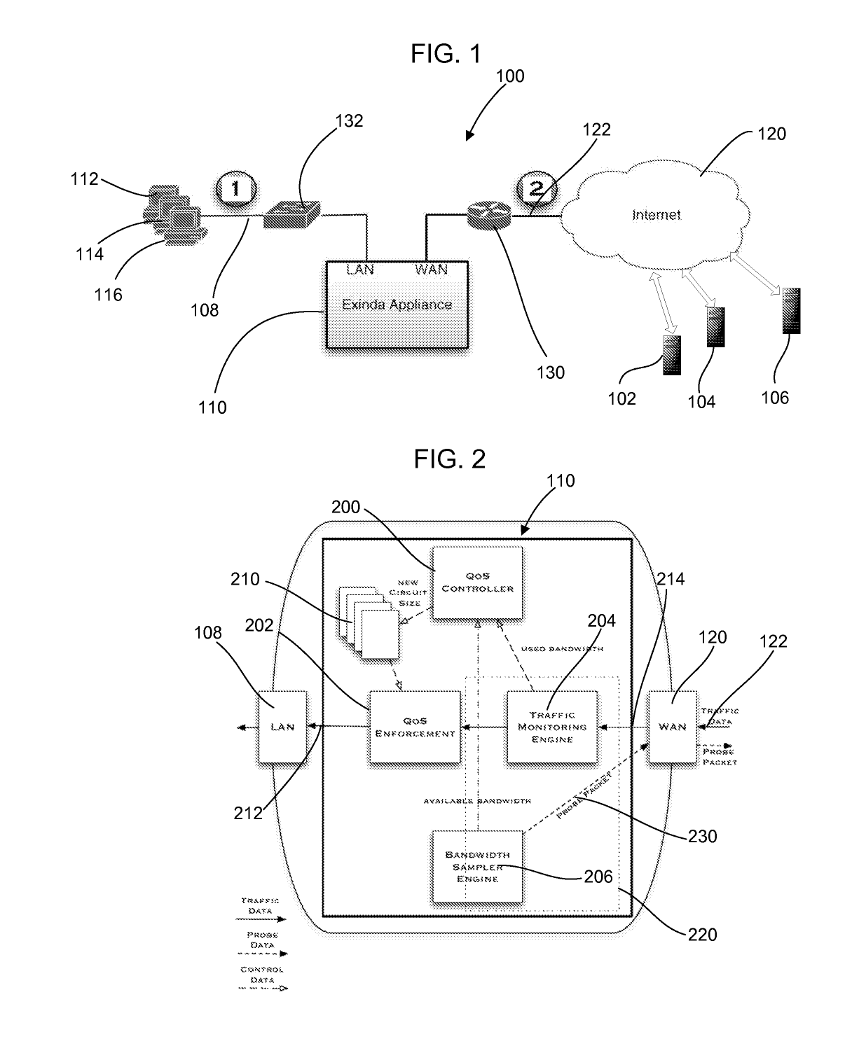

FIG. 1 shows a network system 100 that may include a series of one or more application servers 102, 104, and 106 coupled through a wide area network 120 to a local area network 108 via a traffic management appliance 110. The application servers 102, 104, 106, and the traffic management appliance 110 may be network nodes of the local area network 108. The local area network 108 may also include other nodes such as computers 112, 114, and 116. It is to be understood that the servers 102, 104, and 106 may be hardware or software or may represent a system with multiple servers that may include internal networks. In this example the servers 102, 104, and 106 may be hardware server devices, which run network based applications such as voice over IP (VOIP) services, P2P services, streaming services, database services, file sharing services, instant messaging, interactive services, mail services, or web services, which are delivered via the wide area network 120. Further, additional servers and workstations and other devices may be coupled to the system 100 or the local area network 108 and many different types of applications may be available on servers coupled to the system 100. As will be explained below, the local area network 108 may allow network nodes to exchange packets that include trailers having back channel data, such as traffic management data. Each of the network nodes, such as application servers 102, 104, and 106, traffic management appliance 110, and computers 112, 114, and 116, include a network interface such as a network interface card for establishing a communication channel to another network node.

The wide area network 120 may include any publicly accessible network environment, such as the Internet, which includes network components, such as public servers that are not directly managed or under direct control by the traffic management appliance 110, yet whose operation may still be influenced in unique, novel, and unexpected ways in response to TCP/IP protocol directives strategically purposefully determined and sent from the traffic management appliance 110 to make the local area network 108, and perhaps the wide area network 120, operate more efficiently, as will be described in greater detail herein. It should be noted, however, that the ensuing descriptions of the various functionalities relating to the servers 102, 104, and 106 are generally applicable to the network devices coupled to the wide area network 120, and thus the remaining description will simply refer to either one as servers 102, 104, and 106 unless noted otherwise. The wide area network 120 is coupled via a network circuit 122 to a router 130, which is used to route network traffic to and from the wide area network 120 through the traffic management appliance 110.

In this example, the local area network 108 may be a local area network (LAN) environment employing any suitable interface mechanisms and communications technologies including, for example telecommunications in any suitable form (e.g., voice, modem, and the like), Public Switched Telephone Network (PSTNs), Ethernet-based Packet Data Networks (PDNs), combinations thereof, and the like. Moreover, local area network 108 may be made up of one or more interconnected LANs located in substantially the same geographic location or geographically separated, although the local area network 108 may include other types of networks arranged in other configurations. Moreover, the local area network 108 may include one or more additional intermediary and/or network infrastructure devices in communication with each other via one or more wired and/or wireless network links, such as switches, routers, modems, or gateways (not shown), and the like, as well as other types of network devices including network storage devices. The local area network 108 is coupled via a LAN switch 132 to the traffic management appliance 110.

The traffic management appliance 110 may be interposed between the wide area network 120 and the local area network 108 as shown in FIG. 1. In this example, the WAN 120 provides users such as the computers 112, 114, and 116 on the LAN 108 with access to servers and systems on the Internet or in other physical locations. By placing the traffic management appliance 110 with quality of service capabilities between the LAN 108 and the WAN 120, access to the WAN services may be regulated to ensure that some applications or users have preferential access, thus ensuring efficient use of network resources for critical application use.

From the perspective of the clients of the local area network 108, they have directly established a connection in the usual way to the appropriate servers 102, 104, and 106 and respective server applications. The existence of a proxy connection may be entirely transparent to a requesting client computer. The implementation of such a proxy may be performed with known address spoofing techniques to assure transparency, although other methods could be used. The traffic management appliance 110 may provide high availability of IP applications/services running across multiple servers such as the servers 102, 104, and 106.

FIG. 2 is a block diagram of the traffic management appliance 110. In this example, the traffic management appliance 110 may be one of the series 4761 traffic management appliances available from Exinda Networks PTY, Ltd. of Australia. The traffic management appliance 110 may provide a connection to the wide area network (WAN) 120 and manage traffic to and from the wide area network 120 to the local area network 108 and the devices therein. Optimizing the WAN connections to the LAN 108 allows network administrators to prioritize inbound and outbound traffic on the network circuit 122 coupled to the wide area network 120 based on a variety of factors. Traffic can be prioritized and de-prioritized by application type, who is generating the traffic, and the time of day the request is being made. For example, traffic flowing between a branch office and the head office network can be prioritized over any other traffic. The traffic management appliance 110 provides all of the core capabilities needed to effectively manage a network circuit such as the network circuit 122 from the WAN 120. These tightly integrated capabilities include real-time monitoring, reporting, traffic control, optimization, and intelligent acceleration.

In this example, the traffic management appliance 110 may include a QoS controller 200, a quality of service (QoS) enforcement module 202, a traffic monitoring engine 204, and a bandwidth sampler engine 206. The QoS enforcement module 202 accesses stored rules or policies 210 for managing network traffic through the attached network circuit 122. The policies are executed by the QoS enforcement module 202. The LAN 108 is coupled via the LAN switch 132 to a local area network port 212 that is regulated by the QoS enforcement module 202 to determine the allocation of the network circuit bandwidth to a particular traffic request. As will be explained below, the policies 210 configure the enforcement module 202 based on the actual bandwidth of the network circuit 122, which is determined by the controller 200 based on data received from the traffic monitoring engine 204 and the bandwidth sampler engine 206. Since the policies are often defined in terms of a percentage of the network circuit bandwidth, new absolute values for bandwidths of the shaping policies are computed by the controller 200 and sent to the QoS enforcement module 202 for enforcement of the policies 210.

Communications between the network nodes on the local area network 108 may be conducted via the Ethernet standard in this example. Communications may be made in a data payload in an Ethernet packet sent between a source node and a destination node on the local area network 108. The network switch 122 is coupled to the traffic management appliance 110 through the router 130 to a wide area network port 214.

In FIG. 1, users on the LAN 108, such as those of computers 112, 114, and 116, have all of their traffic flow through the traffic management appliance 110, which applies its QoS rules and policies from the QoS enforcement module 202. A client computer on the LAN 108, such as the computer 112, will make a request to a website that may be operated by the server 102 coupled to the WAN 120. For example, a user may log on to a website. This request has to compete with all the other WAN bound requests and responses. The QoS enforcement module 202 in the traffic management appliance 110 shapes the network traffic allocated to the user requests such as that for web access according to the rules (policies) that the user has configured. This allows certain traffic to be guaranteed certain portions of the link and other traffic to be limited to certain portions.

In this example, the traffic management appliance 110 serves as a quality of service system that performs traffic shaping and allows a user to configure different amounts of the network 120 allocated to the various requests from nodes on the local area network 108 to set aside for different applications via the policies 210. For instance, a user may allocate 30% of the network circuit to Voice over IP (VOIP) traffic run by a server such as the server 104 in FIG. 1. The traffic management appliance 110 then ensures that if the VoIP traffic requires up to 30% of the network circuit bandwidth, the VoIP traffic will get up to 30% of the network circuit bandwidth. If VoIP traffic on the LAN 108 doesn't need 30% of the bandwidth at the moment, the traffic management appliance 110 will allow lower priority traffic to use the network circuit bandwidth allocated to VoIP traffic.

This percentage of the network capacity may also be used when the actual bandwidth is lower than expected to guarantee that a certain type of traffic doesn't use more than a set amount, e.g., 20%, of the network bandwidth. For instance, an educational user may put in policies that limit the amount of P2P traffic to 10% of their network bandwidth since such traffic should not be blocked completely but such a user does not want such traffic to overrun their network and disrupt business critical traffic.

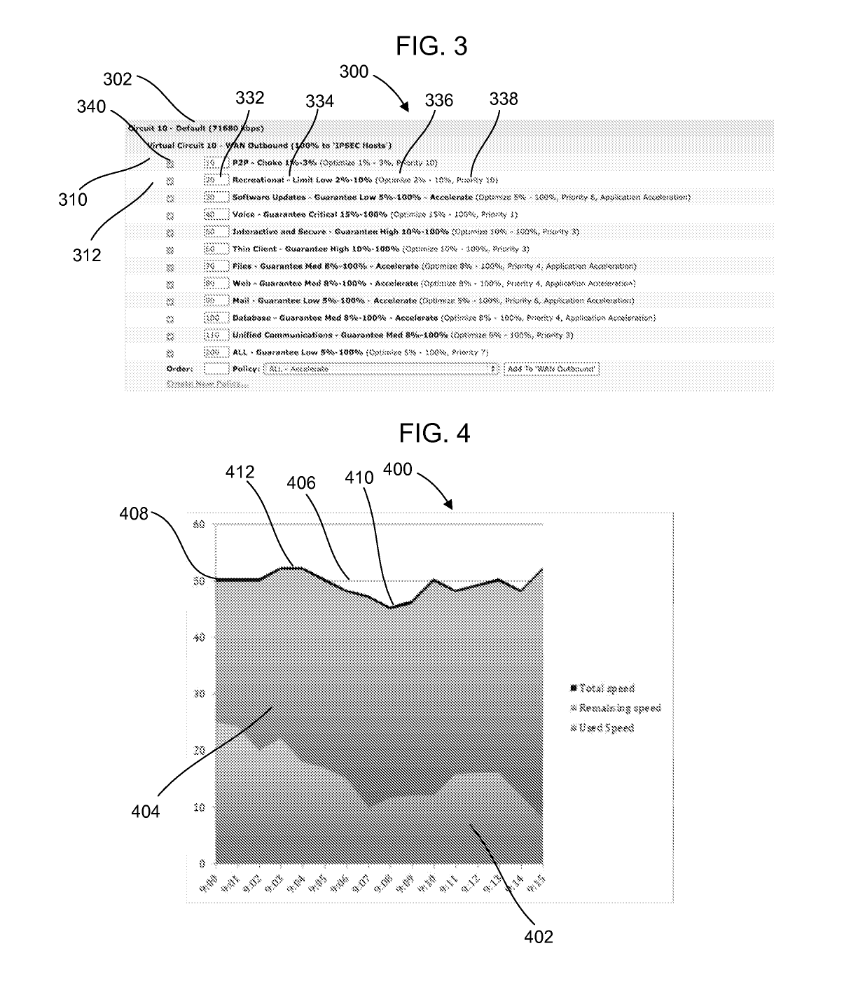

FIG. 3 is a screen image of a user interface 300 for a network administrator to view and modify policies for the QoS enforcement module 202 in FIG. 2. The user interface 300 in FIG. 3 includes a summary field 302 associated with of a network circuit such as the network circuit 122 managed by the traffic management appliance 110. The summary field 302 includes data such as the fixed bandwidth amount for the network circuit 122.

The user interface 300 includes a list of active policies 310, which includes summary fields 312 of each active policy. A typical policy summary field 312 includes a placement order entry box 332, a description 334, an optimization and guarantee field 336, and a priority field 338. An enable/disable control 340 for each policy represented by the summary fields 312 allows policies to be turned on and off. The placement order entry box 332 is used to control the order of the policy within the execution of the policy in the QoS enforcement engine 202. The description 334 is used to provide a human readable name for each policy. The optimization and guarantee field 336 shows the minimum and maximum amount of bandwidth that will be provided to the network traffic that is affected by this policy rule. The priority field 338 controls which traffic is considered higher or lower priority relative to the other traffic. In this example, priority 1 is considered the highest priority traffic and is given preferential treatment when it is competing with other traffic for bandwidth.

In this example, a customer may purchase an internet network link from an Internet Service Provider, such as the network circuit 122, providing access to the wide area network 120. The ISP would provide a link such as the network circuit 122 providing access to the wide area network 120 in FIG. 1 that has a “fixed” or “configured” bandwidth.

The disparity in actual network bandwidth and that based on the traffic policies 210 may be overcome by using an application tool run on the bandwidth sampler engine 206 to detect the available bandwidth of the network circuit 122. An example of such application tools may include the AB-Cap, Abing, ASSOLO, DietTopp, IGI, pathChirp, Pathload, PTR, Spruce, and Yaz. Of course any appropriate method may be used to estimate the true bandwidth of the network circuit 122. By using a network bandwidth detection module 220 including the traffic monitoring engine 204 and the bandwidth sampler engine 206, the controller 200 may periodically sample the true bandwidth of the network switch of the network 120. As shown in FIG. 2, the bandwidth sampler engine 206 sends out a probe packet (part of the packet dispersion techniques) 230 every minute to the network switch 122 in this example. It uses that packet information to determine the available bandwidth and sends that available bandwidth information (along with when that bandwidth sample was taken to the controller 200. The controller 200 also gets the amount of traffic seen on the network circuit 122 at that same sampling time; this becomes the used bandwidth in the calculation of total circuit bandwidth provided by the service provider. Once the QoS enforcement module 202 has determined the true bandwidth of the network circuit 122, this may be used to alter the configured value of the bandwidth of the network and dynamically modify the policies governing network traffic on the traffic management appliance 110.

By doing so, the traffic management appliance 110 including the QoS enforcement module 202 adjusts the total bandwidth available down when the network circuit 122 has momentarily lost capacity. As a result, the QoS enforcement module 202 will employ all of its algorithms in the policies for proper traffic management and will therefore start prioritizing the traffic, allowing the higher priority traffic to get more bandwidth from the lower priority traffic.

In the case where higher bandwidth is available from the wide area network 120, the controller 200 detects this higher bandwidth and will allow the QoS enforcement module 202 to increase the bandwidth of the network circuit 122 temporarily. This enables the traffic management appliance 110 to allow more traffic on the network 108 and therefore not waste the excess bandwidth. When the period of increased bandwidth on the network circuit 122 is over, the controller 200 would again detect the new bandwidth level and adjust the size of the bandwidth of the network circuit 122 back to its true size so the traffic is properly managed again.

FIG. 4 is a graph 400 of a typical network speed over the course of time in a typical network system such as the system 100 in FIG. 1. FIG. 4 shows a first area 402 representing the percentage of network bandwidth used by the network circuit 122 at any given time. A second area 404 shows the unused part of the bandwidth of the network circuit 122 at any given time. A line 406 shows the predicted or forecast bandwidth of the network circuit 122. A line 408 shows the actual bandwidth of the network circuit 122 over time, which is calculated from the actual bandwidth used and the remaining bandwidth as determined by the traffic monitoring engine 204 and the bandwidth sampling engine 206 in FIG. 2.

As may be seen in the line 408 in FIG. 4, the network bandwidth is unpredictable in terms of the actual bandwidth provided by the network circuit 122. This bandwidth may fluctuate by over 10% during the course of a day. For example, at a point 410 the actual bandwidth is lower than the predicted or forecast bandwidth 406. At a point 412, the actual bandwidth is higher than the predicted or forecast bandwidth. The QoS enforcement engine 202 takes advantage of the actual bandwidth in order to adjust the traffic management policies 210 to maximize excess bandwidth or prioritize traffic when less bandwidth is available.

The policies 210 managed by the QoS enforcement engine 202 are initially configured with the static configured bandwidth of the network circuit 122, for example, 10 Mb/s. All of the QoS policies 210 are then employed relative to the configured 10 Mb/s bandwidth. For example, if an application is guaranteed to be given 10% of the network circuit bandwidth, then it will be guaranteed to have 1 Mb/s of bandwidth. If the total available bandwidth drops from 10 Mb/s to 9 Mb/s, then the guarantee of 10% would need to drop to 0.9 Mb/s.

Every period (such as every 1-5 minutes), the controller 200 will determine the amount of available bandwidth on the network link via the bandwidth sampler engine 206. The bandwidth sampler engine 206 returns the amount of bandwidth that is available via the probe packet 230 but it does not take into consideration how much bandwidth is currently being used. Thus, the traffic monitoring engine 204 samples the amount of bandwidth that is already being used on the network circuit 122 by the traffic flowing through the traffic management appliance 110. This data may be used in conjunction with the data on available bandwidth by the controller 200 to determine the actual bandwidth at the time the samples are taken.

The total capacity of the network circuit 122 is the sum of the available bandwidth, as determined by the bandwidth sampler engine 206, and the used bandwidth as determined by monitoring the traffic flowing via the traffic monitoring engine 204. If the total available bandwidth is different from the currently configured network circuit bandwidth, then the configuration is changed. This will have the effect of changing the percentage based policies to match the new available bandwidth. In the case above, this would have the effect of dropping the 1 Mb/s policy to 0.9 Mb/s since the true bandwidth is less than the configured bandwidth.

This adjustment happens periodically in this example such as every minute. The more frequently the sampling occurs, the more accurate the traffic shaping and prioritization will be by the traffic management appliance 110. During the normal operation of the traffic management appliance, the circuit bandwidth is measured at an appropriate interval and automatic adjustment of the circuit bandwidth and the policy values are made. Alternatively, the controller 200 may monitor the used traffic data determined by the traffic monitoring engine 204 and only determine the actual bandwidth when the used traffic is above a threshold level of the configured bandwidth. For example, the threshold level could be 50% of the configured bandwidth. Thus, when the used traffic exceeds 50% of the configured bandwidth, the controller 200 would determine the actual bandwidth and make adjustments to the policies 210 based on the actual bandwidth. This increases efficiency by reducing the amount of bandwidth consumed by the probe packets and reduces the calculations performed by the traffic management appliance 110.

An example of use of the system 100 to efficiently allocate bandwidth may assume a simple policy that has a network circuit having a bandwidth of 50 Mb/s. A first policy enforced by the QoS enforcement module 202 may be that all Peer to Peer traffic may only take 5% of the circuit bandwidth. From the static configuration of a circuit with a bandwidth of 50 Mb/s, the policy would allocate peer to peer traffic 2.5 Mb/s of the circuit bandwidth. If the controller 200 determines that the circuit bandwidth is only 45 Mb/s at this point in time, then the circuit bandwidth definition of the policy is changed to 45 Mb/s and the 5% of the bandwidth determined from the first policy would be recomputed to be 2.25 Mb/s.

Internet Service Providers who manage network circuits such as the network circuit 122 may provide a burst feature, which is the ability of the network such as the network 120 to momentarily burst to a higher maximum value if the ISP has spare capacity. The example traffic management appliance 110 may use such a feature as the burst would be detected by the controller 200 and control the QoS enforcement module 202 to increase the bandwidth available to the different services for the period of the burst.

Complex QoS systems may introduce levels between the network circuit and policies often called Virtual Circuits. These virtual circuits are often defined in terms of a percentage of the circuit. These virtual circuit definitions would change as well when the actual circuit bandwidth is computed to be something different than the configured circuit bandwidth. This is useful when first configuring the QoS system. Instead of asking the user for a static value for circuit bandwidth, the system 100 can compute the actual circuit bandwidth and present that as the configuration value for the network circuit 122. All further configuration of the system would be based on this initial circuit bandwidth.

Example code for executing the above is shown below

```
Adjust_QoS_Policies( ) {
      Available_bandwidth = Sample_Available_bandwidth( );
      Currently_used_bandwidth = Sample_current_traffic_volume( );
      Total_bandwidth = Available_bandwidth + Currently_used_bandwidth;
Set_QoS_Engine_Total_Bandwidth(Total_bandwidth);
}
```

Each of the client computers 112, 114, and 116; servers 102, 104, and 106; and the traffic management appliance 110 described above may include a central processing unit (CPU), controller or processor, a memory, and an interface system that are coupled together by a bus or other link, although other numbers and types of each of the components and other configurations and locations for the components can be used. The controller 200 in the traffic management appliance 110 may execute a program of stored instructions for one or more aspects of the methods and systems as described herein, including for diagnostics or network traffic management, although the processor could execute other types of programmed instructions. The memory may store these programmed instructions for one or more aspects of the methods and systems as described herein, including the method for increasing the transmission efficiency, although some or all of the programmed instructions could be stored and/or executed elsewhere. A variety of different types of memory storage devices, such as a random access memory (RAM) or a read only memory (ROM) in the system or a floppy disk, hard disk, CD ROM, DVD ROM, or other computer readable medium that is read from and/or written to by a magnetic, optical, or other reading and/or writing system that is coupled to the processor, may be used for the memory. The user input device may comprise a computer keyboard and a computer mouse, although other types and numbers of user input devices may be used. The display may comprise a computer display screen, such as a CRT or LCD screen by way of example only, although other types and numbers of displays could be used.

Although an example of the traffic management appliance 110 is described and illustrated herein in connection with FIG. 1, each of the computers of the system 100 could be implemented on any suitable computer system or computing device. It is to be understood that the example devices and systems of the system 100 are for exemplary purposes, as many variations of the specific hardware and software used to implement the system 100 are possible, as will be appreciated by those skilled in the relevant art(s).

Introducing a process that detects the actual remaining circuit bandwidth solves the problem of overutilized and underutilized bandwidth. In this way, the QoS management engine 202 avoids the problem of prioritizing traffic prematurely and leaving available circuit bandwidth unused. It also avoids the problem of not prioritizing and shaping because the configured circuit bandwidth has not been reached and therefore the QoS policies do not take effect. By combining the packet dispersion algorithms for determining the available circuit bandwidth and the measured values of the existing circuit bandwidth being used, the QoS policies may be dynamically reconfigured so that they are being applied at the appropriate time in the correct manner and thus avoid the problem of leaving some bandwidth unused or not affecting the traffic when it is needed.

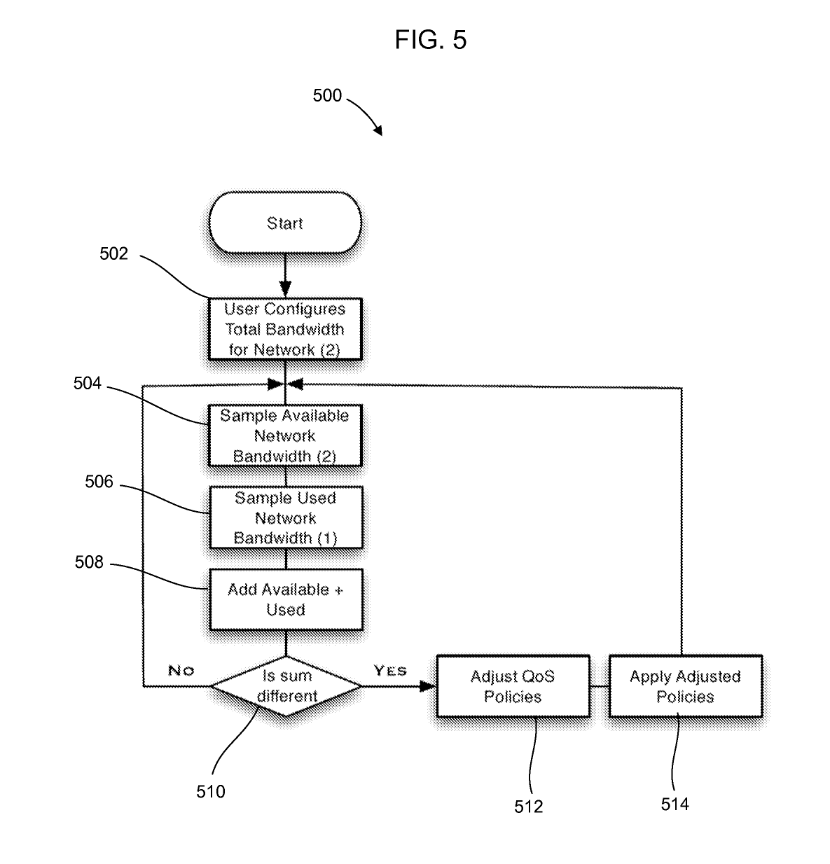

The process of adjusting network traffic policies will now be described with reference to FIGS. 1-3 in conjunction with the flow diagram shown in FIG. 5. The flow diagram in FIG. 5 is representative of example machine readable instructions for adjusting network traffic policies for actual network speed for the system in FIG. 1. In this example, the machine readable instructions comprise an algorithm for execution by: (a) a processor, (b) a controller, and/or (c) one or more other suitable processing device(s). The algorithm may be embodied in software stored on tangible media such as, for example, a flash memory, a CD-ROM, a floppy disk, a hard drive, a digital video (versatile) disk (DVD), or other memory devices, but persons of ordinary skill in the art will readily appreciate that the entire algorithm and/or parts thereof could alternatively be executed by a device other than a processor and/or embodied in firmware or dedicated hardware in a well-known manner (e.g., it may be implemented by an application specific integrated circuit (ASIC), a programmable logic device (PLD), a field programmable logic device (FPLD), a field programmable gate array (FPGA), discrete logic, etc.). For example, any or all of the components of the interfaces could be implemented by software, hardware, and/or firmware. Also, some or all of the machine readable instructions represented by the flowchart of FIG. 5 may be implemented manually. Further, although the example algorithm is described with reference to the flowcharts illustrated in FIG. 5, persons of ordinary skill in the art will readily appreciate that many other methods of implementing the example machine readable instructions may alternatively be used. For example, the order of execution of the blocks may be changed, and/or some of the blocks described may be changed, eliminated, or combined.

FIG. 5 is a flow diagram 500 of the process followed by the traffic management appliance 110 to adjust the network allocation to efficiently use network resources. The flow diagram represents the main algorithm for adjusting QoS to the dynamic nature of the network bandwidth by the controller 200. The controller 200 first accepts user input for the total bandwidth fixed from the configuration of the network circuit 122 (502). The controller 200 then obtains a sample of available network bandwidth from the bandwidth sampler engine 206 (504). The controller 200 then samples the used network bandwidth from the traffic monitoring engine 204 (506). The controller 200 adds the sampled values to determine the actual bandwidth (508). The controller 200 then compares the actual bandwidth with the configured bandwidth (510).

If the actual bandwidth is the same as the configured bandwidth, the controller 200 loops back to take another set of samples after a suitable time period such as one minute. If the actual bandwidth is different from the configured bandwidth, the controller 200 adjusts the policies 210 based on the actual bandwidth (512). The adjusted policies are then applied to traffic received by the traffic management appliance 110 via the QoS enforcement module 202 (514). The controller 200 then loops back to take another set of samples after a suitable time period such as one minute.

Each of these embodiments and obvious variations thereof is contemplated as falling within the spirit and scope of the claimed invention, which is set forth in the following claims.

1. A method of efficient network traffic management for improved operation of a computing device, the method comprising:
allocating a part of a bandwidth of a network circuit to provide network traffic to a computing device according to a policy based on a configured bandwidth of the network circuit;
determining the actual bandwidth of the network circuit;
adjusting the policy for allocating a part of the bandwidth of the network circuit for the network traffic provided to the computing device based on the determined actual bandwidth; and
regulating the network traffic to the computing device according to the adjusted policy.

2. The method of claim 1, wherein the determined actual bandwidth of the network traffic to the computing device is greater than a configured bandwidth resulting from a burst of increased network circuit bandwidth and the bandwidth of the network circuit for network traffic provided to the computing device is increased.

3. The method of claim 1, wherein the computing device is provided a first service via the network traffic provided by the network circuit, wherein the first service is allocated a first predetermined percentage of network circuit bandwidth by the policy.

4. The method of claim 3, wherein the first service includes one of a group of voice over IP (VOIP) services, P2P services, streaming services, database services, file sharing services, instant messaging, interactive services, mail services, or web services.

5. The method of claim 3, wherein the policy allocates a predetermined percentage of the bandwidth to the first service, and the policy is adjusted to increase the bandwidth if the determined actual bandwidth is greater than the configured bandwidth.

6. The method of claim 3, wherein the policy allocates a second predetermined percentage of the network circuit bandwidth to a second service.

7. The method of claim 6, wherein the policy prioritizes the second service, and wherein the bandwidth allocated to the first service is decreased if the actual bandwidth is less than the configured bandwidth.

8. The method of claim 1, wherein the actual bandwidth of the network circuit is determined by measuring the bandwidth of the network circuit used by network traffic and the unused bandwidth of the network circuit.

9. The method of claim 1, wherein the actual bandwidth of the network circuit is determined at predetermined time intervals.

10. The method of claim 1, further comprising measuring the actual network traffic bandwidth and wherein the actual bandwidth of the network circuit is determined if the actual network traffic bandwidth is greater than a predetermined percentage of the configured bandwidth.

11. A traffic management appliance for regulating network traffic between a computing device and a network circuit having a configured bandwidth, the network appliance comprising:
a local area network port for receiving and transmitting traffic from the network circuit to the computing device according to a policy based on a configured bandwidth;
a WAN port for receiving and transmitting traffic from the network circuit;
a network bandwidth detection module coupled to the WAN port;
a controller coupled to the network bandwidth detection module to determine the actual bandwidth of the network circuit;
a quality of service enforcement module coupled to the LAN port for regulating network traffic to the computing device according to the policy, the quality of service enforcement module adjusting the policy based on the determined actual bandwidth of the network circuit.

12. The appliance of claim 11, wherein the determined actual bandwidth of the network traffic to the computing device is greater than the configured bandwidth resulting from a burst of increased network circuit bandwidth and the bandwidth of the network circuit for network traffic provided to the computing device is increased.

13. The appliance of claim 11, wherein the computing device is provided a first service via the network traffic provided by the network circuit, wherein the first service is allocated a first predetermined percentage of network circuit bandwidth by the policy.

14. The appliance of claim 13, wherein the first service includes one of a group of voice over IP (VOIP) services, P2P services, streaming services, database services, file sharing services, instant messaging, interactive services, mail services, or web services.

15. The appliance of claim 13, wherein the policy allocates a predetermined percentage of the bandwidth to the first service, and the policy is adjusted to increase the bandwidth if the determined actual bandwidth is greater than the configured bandwidth.

16. The appliance of claim 13, wherein the policy allocates a second predetermined percentage of the network circuit bandwidth to a second service.

17. The appliance of claim 16, wherein the policy prioritizes the second service, and wherein the bandwidth allocated to the first service is decreased if the actual bandwidth is less than the configured bandwidth.

18. The appliance of claim 16, wherein the network bandwidth detection module includes a traffic monitoring engine determining the bandwidth of the network circuit used by network traffic; and a bandwidth sampler engine determining the bandwidth of the network circuit not being used; and wherein the controller determines the actual bandwidth of the network circuit by the used bandwidth from the traffic monitoring engine and unused bandwidth from the bandwidth sampler engine.

19. The appliance of claim 11, wherein the actual bandwidth of the network circuit is determined at predetermined time intervals.

20. A non-transitory, machine readable medium having stored thereon instructions for managing network traffic received through a network traffic appliance, the stored instructions comprising machine executable code, which when executed by at least one machine processor, causes the machine processor to:
allocate a part of a bandwidth of a network circuit to provide network traffic to a computing device according to a policy based on a configured bandwidth of the network circuit;
determine the actual bandwidth of the network circuit;
adjust the policy for allocating part of the bandwidth of the network circuit for the network traffic provided to the computing device based on the determined actual bandwidth; and
regulate the network traffic to the computing device according to the adjusted policy.
